(19) United States
(12) Patent Application Publication
(10) Pub. No.: US 2023/0034630 A1
(43) Pub. Date: Feb. 2, 2023

(54) GRAPHENE DISPERSION AND FUNCTIONALIZATION

(71) Applicant: Chromaflo Technologies Corporation, Ashtabula, OH (US)

(72) Inventors: Santosh K. Yadav, Geneva, OH (US); Paul A. Rettinger, Ashtabula, OH (US)

(73) Assignee: Chromaflo Technologies Corporation, Ashtabula, OH (US)

(21) Appl. No.: 17/814,680

(22) Filed: Jul. 25, 2022

Related U.S. Application Data
(60) Provisional application No. 63/225,378, filed on Jul. 23, 2021.

(51) Int. Cl. C01B 32/19

(52) U.S. Cl. CPC C01B 32/19

(57) ABSTRACT

The present disclosure describes embodiments of novel methods of few layer graphene exfoliation and stabilization using an effective liquid additive package and laminar shear processing regimen. The liquid additive package serves both as a stabilizer and solvent for milling of the dispersion of graphene in media. The novel methods create suitable functionalities on graphene particles and compatibility between the graphene and polymer, which results in stronger interfacial interaction and complete exfoliation. The complete exfoliation of graphene and substantial interfacial interaction between graphene and the polymer matrix have a significant positive impact on the electrical, thermal, and mechanical properties of the composite. Such positive impacts are due to uniform dispersion and stabilization of graphene throughout the polymer matrix; strong interfacial interaction between graphene particles and polymer chains; and sufficient interstitial separation between graphene particles within the matrix so as to allow for load transfer throughout the composite material.

### CROSS REFERENCE TO RELATED APPLICATION

This application claims priority to U.S. Provisional Patent Application Ser. No. 63/225,378, titled “Graphene Dispersion and Functionalization,” filed on Jul. 23, 2021, which is expressly incorporated by reference herein in its entirety.

### FIELD OF INVENTION

The present disclosure generally relates to novel methods for graphene exfoliation and stabilization. More specifically, the present disclosure relates to novel methods for “few-layer” graphene exfoliation and stabilization using a liquid additive package and laminar shear processing regimen, where the liquid additive package is both a stabilizer and solvent that facilitates dispersion.

### BACKGROUND

The natural availability and exceptional properties of graphene make it a desirable material for a number of uses and applications. Graphene can be used to form graphene-polymer composites and coating. For example, graphene is a good candidate for use as an additive to polymers and other such materials to create or improve mechanical, electrical, and thermal properties of composite materials. However, the know prior art methods do not sufficiently disperse graphene within a medium such as a polymer to significantly create or improve mechanical, electrical, or thermal properties. In fact, certain prior art methods result in decreased properties as compared to the polymer material alone.

There is a need for simple, cost-effective, and scalable methods for top-down graphene exfoliation and stabilization that result in improved properties of composite materials formed using such graphene exfoliation and stabilization methods. Disclosed herein are such methods for exfoliating and stabilizing graphene for use in forming a composite material with improved mechanical, electrical, and thermal properties.

### SUMMARY

The present disclosure describes embodiments of novel methods of few layer graphene exfoliation and stabilization using an effective liquid additive package and laminar shear processing regimen. The liquid additive package serves both as a stabilizer and solvent for milling of the dispersion of graphene in media. The novel methods create suitable functionalities on graphene particles and compatibility between the graphene and polymer, which results in stronger interfacial interaction and complete exfoliation. The complete exfoliation of graphene and substantial interfacial interaction between graphene and the polymer matrix have a significant positive impact on the electrical, thermal, and mechanical properties of the composite. Such positive impacts are due to uniform dispersion and stabilization of graphene throughout the polymer matrix; strong interfacial interaction between graphene particles and polymer chains; and sufficient interstitial separation between graphene particles within the matrix so as to allow for load transfer throughout the composite material.

### DETAILED DESCRIPTION

The apparatus, systems, arrangements, and methods disclosed in this document are described in detail by way of examples. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of apparatus, arrangements, and methods for dispersion and functionalization of graphene for use in forming composite materials are hereinafter disclosed and described in detail.

In recent years, nanocarbon-based composites have proven to be very useful. Dispersing particles, sheets, or tubes of nanocarbon in a polymer matrix can form high-performance lightweight composites that can be tailored or “tuned” to a variety of specific applications. Graphene, a stiff two-dimensional carbon material, is an excellent building block for high performance polymeric composite materials. Graphene sheets offer exceptional electronic, thermal, and mechanical properties and can be useful in a variety of fields as a material composite, such as in energy applications and as a reinforcing agent in material science. “Few-layered” graphene sheets are also very useful. The term “few-layered” is used to mean graphene sheets that are 10 atomic layers or less. Graphene-polymer nanocomposites with low nanofiller content offer great promise for strong, durable, and multifunctional materials. To date, the challenge for achieving proficient graphene dispersion has poses substantial obstacles in the field of material science. Methods for achieving such proficient dispersion of graphene are disclosed and described herein.

To achieve proficient dispersion of graphene, surfactants and polyelectrolyte can be used to enhance exfoliation and dispersion of graphene in various polymer matrixes through physical or electrostatic interactions. One effective method of improving graphene dispersion and interfacial bonding between graphene and a polymer matrix is the chemical functionalization of graphene. Organic molecules and resin monomers can be attached to graphene surfaces to enhance dispersion. Particularly, the covalent attachment of polymers onto graphene is effective because the grafted polymers on the surface can inhibit the aggregation of graphene. Pristine graphene is a hydrophobic material and has limited dispersibility and compatibility in most resins and solvents. However, processing methods for graphene composites can achieve the desired graphene dispersion.

It is not unusual for graphitic nanoplatelets to contain a certain quantity oxygen covalently bonded to the matrix. The form that such oxygen takes may vary and include phenolic hydroxyls, oxirane rings, and/or carboxylic acid groups. A high level of oxygen is associated with modifications of graphene, such as graphene oxide (GO) or reduced GO surface. These oxygen groups frequently make convenient sites for the practice of functionalization of graphene, whether by π-π bonding, dipole-dipole interaction, ionic bonds, or covalently bonding. It follows that to improve dispersion of graphene in polymeric matrix, different functional groups can be attached to the carbon backbone by chemical modification, covalent, or noncovalent functionalization.

Compared to covalent functionalization, noncovalent functionalization based on the van der Waals force or the π-π interaction provides certain benefits. For example, a less negative impact on the structure of graphene and its derivatives, but also the possibility to tune solubility and electronic properties. There are several approaches to exfoliate and disperse graphene into solvents or resin matrix including mechanical exfoliation as well as chemical methods. The main challenge is to prepare dispersible and near defect-free graphene sheets. Graphene sheets tend to precipitate due to aggregation as a result of strong π-π interactions of graphene sheets in solvents, monomers, or polymers. Chemical functionalization of graphene through noncovalent or covalent approaches improve the stability and processing of dispersed graphene and may introduce new properties as well as allow tuning of the properties of final applications.

In one exemplary method described herein, dispersibility is provided by using mechanical exfoliation via a three-roll mill and a suitable and effective additive package to tailor the dispersibility of graphene in various solvent and resin systems. Two important factors to consider for exfoliation and stabilization of graphene are: (i) applied shear stress and (ii) dispersion chemistry. Shear stress is required for exfoliation, whereas a good and effective additive environment stabilized graphene sheets and prevents restacking. The exemplary method includes mixing few-layers graphene into a solution of amine polymer and trimethoxy vinyl silane using a flat blade. The resulting suspension is then processed with a three-roll mill. An example formulation is listed in Table 1 below.

TABLE 1

| Material | Amount in grams |
|---|---|
| Few Layer Graphene | 362.32 |
| Amine Polymer | 565.22 |
| Trimethoxyvinyl silane | 72.464 |
| Total Batch Size (g) | 1000 |

The following experiment and results provide insight into the usefulness of this exemplary method.

Graphene Sample Preparation. In one embodiment, several commercially available, undispersed, dry-powder few-layer graphene (“FLG”) samples were obtained for evaluation. The dry FLG samples were incorporated into a resin matrix under high shear agitation, and subsequently dispersed via processes, in such a manner as to avoid introduction of undesired defects. The dispersed samples evaluated in accordance with methods discussed herein. First, a solution of the additive package was prepared by mixing various composition of amine polymers and silanes into a half-gallon tin cane using a flat blade. Subsequently, FLG was added slowly while mixing the solution. After the completion of the graphene addition, the paste was passed three times on a three-roll mill to obtain a masterbatch of graphene. This masterbatch of graphene is used to prepare composites with varying percentages of graphene.

Compounding, Molding, and Sample Preparation. In one embodiment, the stable graphene dispersion was blended with polyester resin in varying proportion (0.01%-3.00% w/w), and cured using 1.5% w/w of t-butyl peroxybenzoate. The blended resin solution was poured into a rectangular preheated metal mold and cured at 150° C. for one hour. Further the samples were cut into an average dimension of 35 mm×12.8 mm×3.25 mm for the dynamic mechanical analyzer (DMA) testing. For the conductivity measurement several panels were molded with 14.5% (w/w) of glass fiber on a hot press at 157° C.

Raman Microscopy and Characterization. a Renishaw InVia Raman Microscope was utilized to characterize the graphene samples before, during, and after the dispersion process. This instrument employed a 514 nm Ar-ion laser to produce excitation of the hexagonal planar-carbon matrix, resulting in three distinct emission peaks for the samples that were evaluated: (i) the R-emission peak was measured from 1344 to 1367 cm′ with a mean wavelength (λ) of 1355.4 cm⁻¹; (ii) the G-emission was characterized from 1577 to 1587 cm′ with a mean wavelength (λ) peak of 1380.9 cm⁻¹; and (iii) in the specimens evaluated, a 2D-emission was observed in the region from 2600 to 2800 cm⁻¹ with multiplex peaks that were of greatest intensity between 2720 to 2734 cm⁻¹ and a mean peak wavelength (λ) of that was typically identified between 2725 and 2731 cm⁻¹.

An average of three spectra were collected from each specimen from multiple locations. Cosmic noise was eliminated from our spectra using single-data point reduction, and the spectra were normalized and averaged mathematically. In addition, ten-point averaging was used to reduce overall noise within the spectra. An example of the effect of averaging is shown in Graph 1, which is a Raman spectrum of a sample, normalized vs ten-point averaging.

In Graph 1, the average intensity of the D emission peak at 1363 cm⁻¹ can be compared and contrasted with that of the G emission peak at 1581 cm⁻¹, and 2D emission at 2728 cm⁻¹. Ratios between relative peak intensities were characterized and computed prior to 10-point averaging. Each of the emission peaks characterized in this study offer insight into the characteristics of the FLG that is be evaluated.

The FLG Sample dry power was used to make three dispersions of similar but differing composition: (i) Dispersion A used 33.0% by weight of FLG in a commercially available 100% nonvolatile unsaturated polyester with a nominal viscosity of 2000 cP; (ii) Dispersion B used 33.0% of FLG in a commercially available 100% nonvolatile unsaturated polyester with a nominal viscosity of 300 cP; and (iii) Dispersion C used 36.3% of FLG in a functionalized polyester designed for improved compatibility with crosslinked, unsaturated polyester matrixes. The Raman spectrum of Dispersion C is illustrated in Graph 2.

With respect to Dispersion C, the ratio between D and G peaks increased from 0.145 to 0.213—an increase in the D:G ratio of 47.0%. In addition, there is a qualitative distinction emerging in the 2D peak at 2730 cm⁻¹ that is indicative of a qualitative change in the degree of exfoliation between dry powder and final dispersion. The data of Graph 2 illustrate two specific characteristics of Dispersion C that distinguish it from Dispersion A. The first is that there is evidence of an increase in the functionalization of FLG present in Dispersion C versus the same FLG as undispersed in dry powder form. The second is that there is evidence of an increase in the level of exfoliation, indicative of reduction overall number of layers. The significance of these changes are further discussed.

Dispersion Stability Evaluation. Another method of evaluating the characteristics of a graphene masterbatch or dispersion is to dilute the dispersion or masterbatch in a resin or solvent medium of choice, and determine the suspension stability of the diluted dispersion in that medium over a period of time. In one example of this work, the above dispersions of FLG were diluted to 0.10% (w/w) FLG in styrene, and stored for thirty minutes. Styrene was selected for this example because it is a common monomer for use in such applications as bulk molding compounds (BMC), sheet molding compounds (SMC), pultrusion, etc. If a dispersion is stable in styrene, it is likely to be stable in an application that utilizes high concentrations of styrene monomer. In reviewing the test results, conducted in duplicate for each dispersion, it is clear that when dispersed in styrene monomer, Dispersions A and B have the ability to re-agglomerate quickly, and settle out of suspension. By contrast, a polyester oligomer that has been functionalized for use with FLG and styrene has the necessary functional affinities to produce a stable suspension. Although a stable suspension is capable of eventually settling over time, a truly functionalized and stable dispersion is readily re-dispersible by hand-shaking gently back into suspension. For reasons that will become apparent, this is important when selecting (or creating) a graphene dispersion for use with a given application.

Electrical Property Characterization. Electrical characteristics of composites that are created when Dispersions A, B, and C are incorporated into a neat vinyl ester resin system and cured are evaluated. Dispersions A and B are neat dispersions of FLG into low viscosity, 100% non-volatile, commercially available polyester resins, at loadings of 33% based on weight (w/w). Table 2 below illustrate the levels of electrical resistivity that results when the composite made using Dispersions A and B is cured. Graph 3 shows FLG composites ranging from no FLG to as much as 28 parts per thousand (w/w) FLG, based on resin. As demonstrated in Table 2 below, there is little to no effect on electrical conductivity produced in a composite comprised of a commercially available vinyl ester resin with approximately 30% styrene monomer. Thus, Dispersions A and B are ineffective in creating or improving electrical conductivity over the base polymer.

TABLE 2
Unstabilized FLG in Unsaturated Polyester Resin Matrix

| Concentration | Linear Resistivity |
|---|---|
| (PPT) | (Ω/cm) |
| 0.000 | 3.394E+13 |
| 3.042 | 3.446E+13 |
| 6.018 | 3.362E+13 |
| 11.807 | 3.336E+13 |
| 17.378 | 3.381E+13 |
| 22.744 | 3.381E+13 |
| 27.946 | 2.591E+13 |

Table 3 illustrates the results for composites made from Dispersion C. As noted above, for Dispersion C, a functionalized polyester oligomer was used to compatibilize FLG with unsaturated resins used to make polyester and vinyl ester composites. If the FLG is not functionalized and compatibilized with resin matrix into which it is incorporated, it is unlikely that meaningful benefits will be achieved. However, if the proper steps are taken, as with Dispersion C, FLG can be used to enhance electrical conductivity and mechanical characteristics of a composite material. As illustrated in Graph 4, resistivity drops sharply when the percent of FLG is greater than 1.5% (w/w). While resistivity does not change as the percent of FLG is increased from 0% to about 1.4%, resistivity drops by seven to eight orders of magnitude at about 2% FLG. The resistivity continues to significantly drop as the percentage increases to 2.7% and 3.3%.

TABLE 3
Stabilized FLG in Unsaturated Polyester Resin Matrix

| Concentration | Linear Resistivity |
|---|---|
| (PPT) | (Ω/cm) |
| 0.000 | 3.434E+13 |
| 3.567 | 3.434E+13 |
| 7.056 | 3.425E+13 |
| 13.843 | 3.362E+13 |
| 20.375 | 3.623E+06 |
| 26.667 | 2.183E+05 |
| 32.767 | 7.388E+04 |

Thermomechanical Properties. The impact of graphene dispersions upon thermomechanical properties, including glass transition temperature and modulus of graphene-based composites, were investigated by DMA analysis. Graph 3 includes thermograms of a polyester composite that uses Dispersion C. Graph 3 illustrates storage moduli of composites containing varying percentages of FLG at temperatures ranging from 25-200° C. Storage modulus of plots of neat polyester and FLG-based composite are demonstrated at 0.00% (“control”), 0.01% (w/w), and 0.50% (w/w) of stabilized, functionalized FLG, based on polyester resin. The dispersion that is used to produce this data is Dispersion C.

Illustrated in Graph 3 is the typical behavior of polyester thermoset progressing through the glass transition temperature (approximately 115° C.). It is an unexpected result that as little as 0.01% (w/w) FLG based on resin can increase the modulus by as much as 16% at 25° C. When loading is increased to 0.50% FLG, although we have increased FLG concentration by 50 times, the modulus improvement obtained at 25° C. was about 25% more than the control and only 9% more than for 0.01% (w/w) FLG based on resin. Thus, the data shows that there are diminishing returns as the percentage for FLG is increased, i.e., a point at which no or little additional benefits are realized from adding more FLG to this particular resin matrix. The testing was repeated using samples at 0.50% (w/w) FLG, 1.00% (w/w) FLG, and 3.00% (w/w) FLG based on resin at temperatures ranging from 25-200° C. The results are shown in Graph 4.

As illustrated in Graph 6, for 0.50% (w/w) FLG based on polyester resin, the modulus again increased by 25%. However, when FLG content was increased to 1.00%, the modulus actually decreased to an improvement of only 18% over the control. When FLG content was increased to 3.00%, the resulting modulus again fell to an improvement of only 12% as compared to the control. Again, the tuning of a mechanical property such as storage modulus, there is a specific amount that maximizes the increase in storage modulus. Amount above that specific amount actually decrease the mechanical property of the composite.

It is comparatively straightforward to take a dry FLG powder, add it to resin under agitation, and produce a cured thermoset compound. However, as is demonstrated, this is not likely to result in a compound with optimal or even increased electrical, thermal, and mechanical characteristics. Conversely, it is much more complicated to find specific moieties that are capable of functionalizing FLG, and then introduce these moieties into an FLG dispersion in such a manner as to produce desirable effects. While graphene has been demonstrated to be promising reinforcing agent for high-performance nanocomposites, the challenge is to obtain good dispersions and obtain the full exfoliation of graphene into single- or few-layer material with reasonable lateral dimensions, and without imparting significant damage upon the flakes. It is beneficial to ensure that there is a strong interface between the reinforcement and the polymer matrix to obtain the optimum electrical, thermal, and mechanical properties. For example, if there is not a strong interface between FLG and the polymer matrix, mechanical failure is likely to initiate along the lines of a weakened interface, and result in material that is less robust than its underlying polymer or conventional composites.

Suitable functionalities on graphene particles and compatibility between the polymer and graphene leads to stronger interfacial interaction and complete exfoliation, thus substantially increasing the influence on the properties of the composites. The complete exfoliation of graphene and substantial interfacial interaction between graphene and the polymer matrix should have a significant impact on the electrical, thermal, and mechanical properties. The factors that contribute to significant improvement of a mechanical property such as storage modulus include: (i) uniform dispersion and stabilization of graphene throughout the polymer matrix; (ii) strong interfacial interaction between graphene particles and polymer chains; and (iii) sufficient interstitial separation between graphene particles within the matrix so as to allow for load transfer. Of these factors, the first two have been described above. However, as illustrated by the DMA analyses of composites containing upwards of 0.50% FLG, there is an upward limit on the amount of properly stabilized FLG that can contribute in a positive manner towards increased storage modulus. The implication is that there needs to be room or intersticial separation between nanoplatelets for proper bonding and load transfer to occur. Load transfer, in this context, is the transfer of stabilized force or energy from the polymer matrix to the reinforcing agent. As the quantity of graphene is increased beyond a certain level, a point of diminishing returns is observed, with little or no additional benefit achieved; and in fact, mechanical properties can decline.

It is important to understand that the process of achieving optimized electrical properties is not necessarily the same as for achieving optimized mechanical benefits, nor for thermal properties. For gains in electrical conductivity, it is necessary to achieve a measure of point-to-point contact between nanoplatelets. For gains in mechanical properties, bonding between the polymer and nanoplately, with subsequent load transfer, must occur. For thermal conductivity, neither point to point contact, or nor load transfer are necessary, but only such proximity as to allow for phonon transfer. It follows that for optimal electrical, thermal, and mechanical properties of nanocomposite materials, it is necessary to determine both the quantitative and qualitative levels at which optimum benefits are achieved.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

What is claimed is:

1. A method for of graphene exfoliation and stabilization as described herein.

2. A method for graphene exfoliation and stabilization using a liquid additive package and laminar shear processing regimen as described herein.
